(19) United States
(12) Patent Application Publication
(10) Pub. No.: US 2019/0378647 A1
(43) Pub. Date: Dec. 12, 2019

(54) INDUCTOR

(71) Applicant: Murata Manufacturing Co., Ltd., Nagaokakyo-shi (JP)

(72) Inventor: Kapila WARNAKULASURIYA, Milton Keynes (GB)

(21) Appl. No.: 16/434,527

(22) Filed: Jun. 7, 2019

Related U.S. Application Data
(60) Provisional application No. 62/682,390, filed on Jun. 8, 2018.

(51) Int. Cl. H01F 27/32; H01F 27/28; H01F 27/24; H01F 27/29

(52) U.S. Cl. CPC H01F 27/327; H01F 27/29; H01F 27/24; H01F 27/2823

(57) ABSTRACT

An inductor includes a core, a plate that holds the core, and a flat copper wire wound around the core in a single layer. The flat copper wire is coated with potting.

### BACKGROUND OF THE INVENTION

### 1. Field of the Invention

The present invention relates to power magnetics. More specifically, the present invention relates to high-power inductors.

### 2. Description of the Related Art

FIG. 1 shows an inductor 100 of the related art. The inductor 100 shown in FIG. 1 includes a core 110, two coils 120, and a bracket 130 used to assemble and mount the inductor 100. As shown in FIG. 1, the coil 120 includes two layers of wire: one exposed outer layer of wire wrapped on an inner layer of wire.

However, inductors similar to that shown in FIG. 1 are typically unpotted. Unpotted construction results in a higher temperature rise for a given rating. This requires making a larger size inductor for a particular rating. In cases where varnishing or a fully potted construction is used, this is a much more expensive solution because of the cost of the housing, the large amount of potting material used, and the additional processing time. Furthermore, an inductor such as that shown in FIG. 1 results in higher conductor losses and requires making the inductor larger to reduce heat density and to address the thermal management. Also, a larger inductor requires a corresponding larger mounting footprint that is in conflict with a desire for higher density packaging.

### SUMMARY OF THE INVENTION

To overcome the problems described above, preferred embodiments of the present invention provide potted, amorphous-core inductors each with a potting-coated flat copper coil that achieves reductions in size, footprint, winding losses, and operating temperature as compared to an inductor of the related art.

Preferably, an inductor according to a preferred embodiment of the present invention includes an amorphous core, a center-potted construction, a flat copper wire used in one layer of windings, and silicon potting.

According to a preferred embodiment of the present invention, an inductor includes a core, a plate that holds the core, and a flat copper wire wound around the core in a single layer. The flat copper wire is coated with potting.

The potting is preferably silicon. Preferably, the plate includes two plates on each side of the core, each of the two plates is L-shaped with a short side extending toward the core, and the short sides each include a mounting feature to mount the inductor to a substrate. The core preferably includes an amorphous metal or a high-silicon steel.

The core preferably has a CC construction with a center. The center is preferably potted with a silicon potting. The flat copper wire preferably includes a tapped terminal.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 shows an inductor of the related art.

FIGS. 2 and 3 show an inductor according to a preferred embodiment of the present invention.

FIG. 4 shows a mounting plate that can be used with the inductor shown in FIGS. 1 and 2.

FIG. 5 shows a coil that can be used with the inductor shown in FIGS. 2 and 3.

FIG. 6 is a graph showing Resistance Factor vs. Penetration Ratio.

FIG. 7 shows an inductor according to a preferred embodiment of the present invention.

### DETAILED DESCRIPTION OF PREFERRED EMBODIMENTS

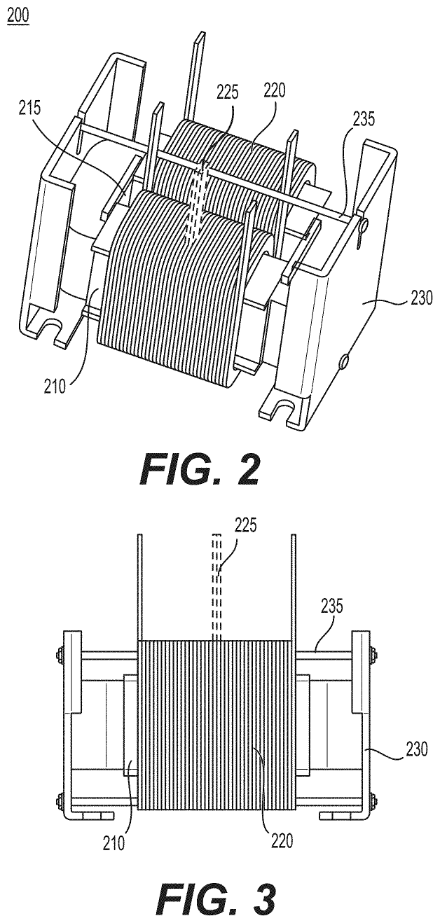

FIGS. 2 and 3 show an inductor 200 according to a preferred embodiment of the present invention. As shown in FIGS. 2 and 3, the inductor 200 can include a core 210, two coils 220, and mounting plates 230. The core 210 can include a ferromagnetic amorphous metal, such as metglas, that allows the core 210 to be magnetized and de-magnetized quickly and effectively with very low core losses. As described below, the core 210 can also include high-silicon steel.

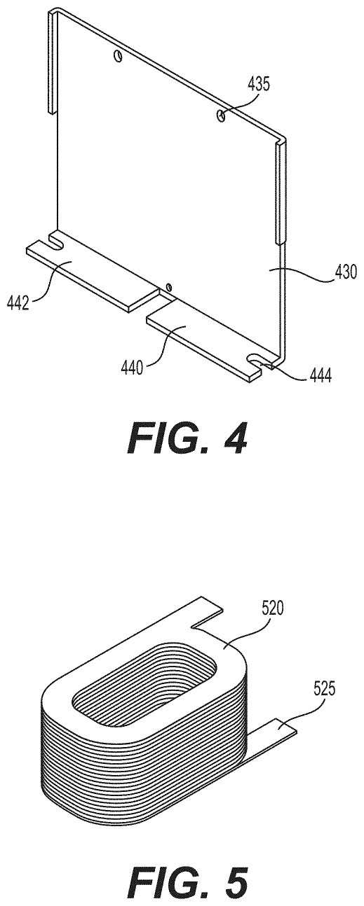

The mounting plate arrangement shown in FIGS. 2-4 can provide a reduction of about 30 mm to about 40 mm of the length of the product compared to that of an inductor of the related art with similar performance parameters. This size reduction can be as high as a 30% reduction in the overall inductor length. As shown in FIGS. 2 and 3, the inductor 200 can include two mounting plates 230 on two opposing sides of the inductor 200 that are connected by one or more bolts 235. In FIGS. 2 and 3, a bolt 235 is shown on the top and on the bottom of the inductor 200, but other arrangements are possible. It is possible to use different numbers and different arrangements of bolts 235. For example, FIG. 4 shows holes 435 for using two bolts 235 on top and one bolt 235 on bottom as shown in FIGS. 2 and 3 or one bolt 235 on top and two bolts 235 on bottom.

As shown in FIG. 4, the mounting plate 430 can be L-shaped with a mounting bracket 440 that includes a short leg 442 extending inward, toward the core. The short leg 442 of the mounting plate 430 can include a slot 444, opening, hole, or other features used to mount the inductor to a substrate such as a printed circuit board. The short leg 422 of the mounting bracket 430 faces inward, which reduces the length of the inductor compared to the prior art mounting bracket that face outward, away from the core. This arrangement of the short leg 442 allows the length of the inductor to be approximately the same as the length of the core, with the difference being the thickness of the mounting plate. As mentioned above, FIG. 4 also shows holes 435 in which bolts can be inserted through to mount the mounting plate 430 to an inductor.

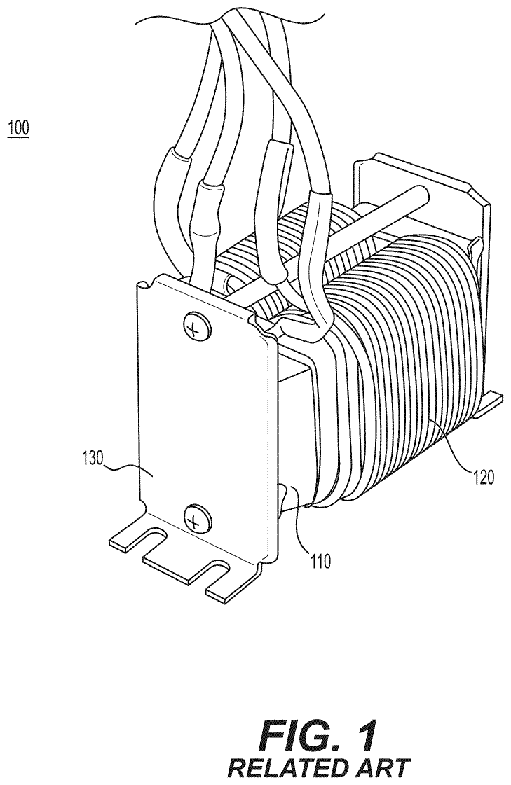

Inductors 100 of the related art usually include copper wires as shown in FIG. 1 that have a circular or rectangular cross section and have several layers of windings. A coil 520 of an inductor according to a preferred embodiment of the present invention includes an edge-wound, flat copper wire 525, as shown in FIG. 5, in only one layer of windings, which considerably reduces the proximity effect in the conductors and thereby correspondingly reduces high frequency losses.

Center-potted construction can be used to build an inductor according to a preferred embodiment of the present invention. In FIG. 2, the center of the core 210 includes a gap 215 that can be filled with potting. The potting can be silicon or other similar potting that is typical of toroidal construction. Center-potted construction is typically used in toroidal transformers and is not used in inductors. The core 210 has a CC construction with a center that is potted. Center-potted construction facilitates the flow of heat from the core 210 and the inner windings to the exterior of the inductor 200. This structure improves the heat flow from the windings of the coil 220 and the core 210, which allow the inductor 200 to operate about 10° C. cooler compared to the industry standard construction. As shown in FIGS. 2 and 3, one of the coils 220 can be tapped by including tapped terminal 225 that is shown using broken lines. The tapped terminal 225 can be defined by two conductors extending from adjacent turns of the coil 220. In FIGS. 2 and 3, only one of the coils 220 includes a single tapped terminal 225, but other arrangements are also possible. For example, the coil 220 can include more than one tapped terminal 225, or each of the coils 220 can include at least one tapped terminal 225. The tapped terminal 225 allows a single product to provide two different inductance values, which can reduce a user's inductor inventory, and increases the versatility of the inductor design, which allows fine tuning of power electronics systems using the inductor design.

Potting dampens a high-frequency audible noise generated by the core 210. This noise is caused by magnetostriction, which cannot be eliminated as it is an inherent part of the magnetizing process. A coating can be applied to the flat copper wire of the coil 220 to reduce the audible noise. The rubberized nature of the coating made with potting serves to dampen this audible noise. The coating or center potting of the core can be made with any suitable potting, including, for example, silicon potting.

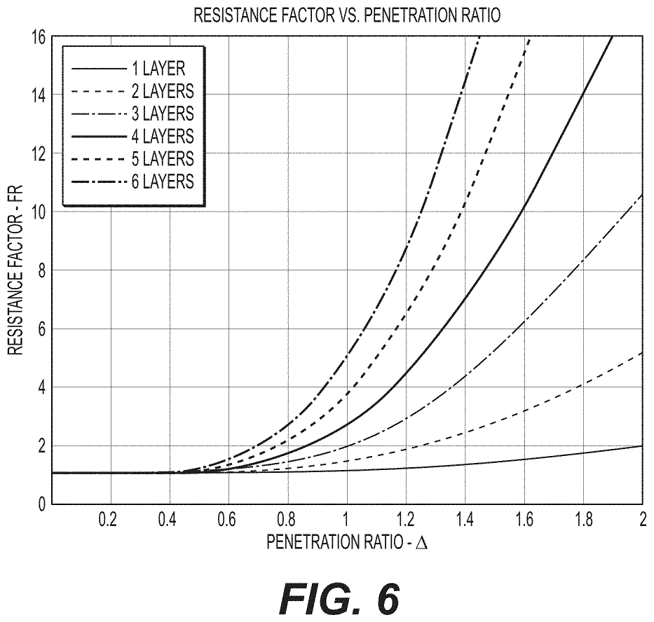

FIG. 6 is a graph showing Resistance Factor (Fr) vs. Penetration Ratio (A) for windings including one to six layers. The Resistance Factor is the ratio between the DC resistance and the AC resistance of a winding. The Penetration Ratio is the ratio between the conductor thickness and the skin depth of a winding for a particular frequency. FIG. 6 shows that the AC resistance increases with the number of winding layers at a particular frequency and penetration ratio. A coating made with silicon potting has the advantage of using a smaller width coil conductor and using fewer turns, both of which result in the inductor operating with smaller resistance factor and penetration ratio, i.e., operating with characteristics towards the left corner of the graph.

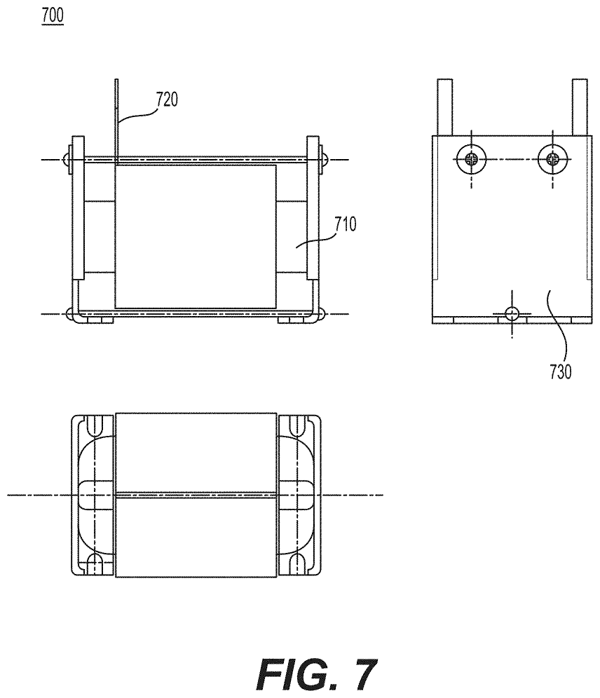

FIG. 7 shows a construction drawing of an inductor 700 according to a preferred embodiment of the present invention including a top view, a front view, and a side view. As shown in FIG. 6, the inductor 700 includes a core 710, a flat copper wire winding creating a coil 720 around the core 710, and two mounting plates 730 on two sides of the core 710.

The construction concepts and improvements discussed above can be used in other similar constructions such as high-silicon core inductors and extended for applications such as magnetics with UU or UI construction, where UU construction includes a two-piece core with two U-shaped pieces and where UI constructions includes a two-piece core with a U-shaped piece and an I-shaped piece. High-silicon core inductors will have the same construction as the amorphous core inductors except that the amorphous core will be replaced by a core with a steel that has high-silicon content, which increases acoustic noise performance.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. An inductor comprising:
a core;
a plate that holds the core; and
a flat copper wire wound around the core in a single layer; wherein
the flat copper wire is coated with potting.

2. The inductor of claim 1, wherein the potting is silicon.

3. The inductor of claim 1, wherein
the plate includes two plates on each side of the core,
each of the two plates is L-shaped with a shorter side extending toward the core, and
the shorter sides of the two plates each include a mounting feature to mount the inductor to a substrate.

4. The inductor of claim 1, wherein the core includes an amorphous metal or a high-silicon steel.

5. The inductor of claim 1, wherein the core has a CC construction with a center.

6. The inductor of claim 5, wherein the center is potted with a silicon potting.

7. The inductor of claim 1, wherein the flat copper wire includes a tapped terminal.
